(19) United States
(12) Patent Application Publication
(10) Pub. No.: US 2021/0095813 A1
(43) Pub. Date: Apr. 1, 2021

(54) MOUNTING GUIDE FOR PLACEMENT OF A GANG BOX

(71) Applicant: BRETT PALMER GUYATT, LAKE HAVASU CITY, AZ (US)

(72) Inventor: BRETT PALMER GUYATT, LAKE HAVASU CITY, AZ (US)

(21) Appl. No.: 16/926,777

(22) Filed: Jul. 13, 2020

Related U.S. Application Data
(60) Provisional application No. 62/872,798, filed on Jul. 11, 2019.
(60) Provisional application No. 62/872,792, filed on Jul. 11, 2019.

(51) Int. Cl. F16M 13/02; H02G 3/12

(52) U.S. Cl. CPC F16M 13/02; H02G 3/121

(57) ABSTRACT

A mounting guide for placing a gang box on a wall structure in a predetermined location includes an elongate substantially planar vertical frame assembly with a longitudinal axis through a vertical body having a top, middle, and bottom portion. The middle portion is formed by an upper and lower lateral wall that extends parallelly from the vertical frame assembly. A laterally extendable box member may be mounted within the middle portion of the frame assembly designed to move laterally away from the vertical body as upper and lower screw members securing the box member are axially rotated. A gang box member may be mounted on a surface of the extendable box or directly to the frame. One or more hoop or clip assemblies are disposed on the frame assembly to secure at least one wire. One or more holes are disposed through the frame assembly for fasteners to surfaces.

### CLAIM OF PRIORITY

This application claims priority to and the benefit of the following applications: U.S. Provisional Application with Ser. No. 62/872,798 filed on Jul. 11, 2019 entitled MOUNTING GUIDE FOR THE PLACEMENT OF A GANG BOX; and U.S. Provisional Application with Ser. No. 62/872,792 filed on Jul. 11, 2019 entitled UNIFORM RECEPTACLE BOX INSTALLATION TOOL, both of which are hereby incorporated by reference in their entireties.

### FIELD OF THE INVENTION

The inventive concept relates generally to a tool and mounting guide for the placement and support of a gang box for the installation of switches and outlets.

### BACKGROUND

Currently, there are a number of solutions for installing gang boxes and other receptacle boxes used in a structure for electrical wiring. One of these solutions attempts to measure out a distance with a tape measure for the placement of a gang box, but this solution fails to meet the needs of the market because the approach is time consuming, and the user may make measuring mistakes. Still another solution seeks to offer gang box installation kits, but this solution also fails to meet market needs because the installation kits do not include proper code measurements and are generally not adjustable. Therefore, there currently exists a need in the market for an apparatus that is a guide for the placement of gang boxes for switches and outlets.

### SUMMARY OF THE INVENTION

The inventive concept in one embodiment is a mounting guide for placing a gang box on a wall structure in a predetermined location. An elongate substantially planar vertical frame assembly has a longitudinal axis through a vertical body and has a top, middle and bottom portion, the middle portion formed by a first lateral wall and a second lateral wall protruding laterally from the vertical body, wherein the first and second lateral walls are perpendicular to the longitudinal axis. A laterally extendable box member is designed to be mounted within the middle portion of the vertical frame assembly and is disposed between the top and bottom portions, the extendable box member designed to move laterally away from the vertical body as upper and lower screw members that secure the box member are axially rotated, the upper and lower screw members perpendicular to the longitudinal axis and aligned with the first lateral wall and the second lateral wall. A gang box member is designed to be mounted on a surface of the extendable box member located away from the vertical body, the gang box having an open end forming a plane that is parallel to the longitudinal axis of the vertical frame assembly. One or more hoop or clip assemblies are disposed on the frame assembly designed to secure at least one wire assembly. One or more hole portions are disposed through the frame assembly designed to receive a fastener assembly therethrough.

In one embodiment of the mounting guide for placing a gang box on a wall structure, the one or more loop or clip assemblies are designed to secure the at least one wire assembly with one or more cable tie assemblies.

In one embodiment of the mounting guide for placing a gang box on a wall structure, the one or more loop assemblies or clip assemblies is a metal-clad wiring bundle style wire holder assembly as exemplified by a Romex clip. One of ordinary skill in the art would recognize that other loop or clip assemblies may be used.

In one embodiment of the mounting guide for placing a gang box on a wall structure, the width of the laterally extendable box member is substantially two inches and the laterally extendable box member is designed to move laterally away from the vertical body up to one and a half inches. This measurement is in accord with a common standard for the placement of gang boxes in construction codes. One of ordinary skill in the art would recognize that the mounting guide could be designed to meet other construction codes now or published in the future.

In another embodiment of the inventive concept, a mounting guide for placing a gang box on a wall structure has an elongate, vertical frame assembly having a longitudinal axis with a vertical body with an upper portion and lower portion, a substantially lower horizontal portion substantially perpendicular to the longitudinal axis and extending from a top end of the lower portion of the frame assembly and a substantially perpendicular upper horizontal portion extending from a bottom end of the upper portion of the frame assembly, the upper horizontal portion and the lower horizontal portion extending laterally at a substantially uniform width, an upper face of the lower horizontal portion opposite a lower face of the upper horizontal portion. A middle portion of the frame assembly is disposed between the upper horizontal portion and the lower horizontal portion and parallel and substantially offset or disposed laterally from the upper portion and lower portion of the frame assembly. One or more hoop or clip assemblies is disposed on the frame assembly designed to secure at least one wire assembly. One or more hole portions is disposed through the frame assembly designed to receive a fastener assembly therethrough.

In one embodiment of the mounting guide for placing a gang box on a wall structure, a substantially horizontally planar foot portion is coupled to a bottom end of the lower portion of the frame assembly, the frame assembly designed to rest on the foot portion when the foot portion is disposed on a surface, the lower portion extending upward from the foot portion a predetermined height for the placement of the gang box between the upper horizontal portion and the lower horizontal portion of the frame assembly.

In one embodiment of the mounting guide for placing a gang box on a wall structure, the lower portion of the frame assembly is substantially ten inches in height. In another embodiment of the mounting guide for placing a gang box on a wall structure, the upper portion of the frame assembly is substantially eight inches or substantially twenty inches in height. One of ordinary skill in the art would recognize that other measurements for the frame assembly could be used and specified.

In one embodiment of the mounting guide for placing a gang box on a wall structure, one or more loop or clip assemblies are spaced substantially six inches from the top end of the lower portion of the frame assembly or the bottom end of the upper portion of the frame assembly. One of ordinary skill in the art would recognize that other measurements for the loop or clip spacing could be used and specified.

In one embodiment of the mounting guide for placing a gang box on a wall structure, the substantially perpendicular lower horizontal portion extending from the top end of the lower portion of the frame assembly and the substantially perpendicular upper horizontal portion extending from the bottom end of the upper portion of the frame assembly, the upper horizontal portion and the lower horizontal portion extending laterally a substantially uniform width, are configured to enable the securing of the gang box to the frame assembly.

In one embodiment of the mounting guide for placing a gang box on a wall structure, the spacing between the substantially perpendicular lower horizontal portion and the substantially perpendicular upper horizontal portion is substantially equal to the vertical height of the mounted gang box assembly, the perpendicular lower horizontal portion and the perpendicular upper horizontal portion designed to couple substantially contiguously to a bottom portion of the gang box assembly and a top portion of the gang box assembly to hold the gang box assembly substantially in place.

In one embodiment of the mounting guide for placing a gang box on a wall structure, at least one clip and hook assembly is coupled to the lower horizontal portion and the upper horizontal portion of the frame assembly and designed to secure the gang box assembly, the gang box assembly held substantially in place by the lower horizontal portion and the upper horizontal portion.

In one embodiment of the mounting guide for placing a gang box on a wall structure, one or more protrusions are disposed on the upper face of the lower horizontal portion of the frame assembly and the lower face of the upper horizontal portion of the frame assembly and designed to prevent the gang box assembly from sliding outward from the lower horizontal portion and the upper horizontal portion of the frame assembly by coupling to corresponding groove portions of the gang box assembly. One of ordinary skill in the art would recognize that friction may be at least partially employed in holding the gang box in place.

In one embodiment of the inventive concept, a method for placing a gang box on a wall structure includes mounting to a surface an elongate substantially planar vertical frame assembly having a longitudinal axis through a vertical body and having a top, middle, and bottom portion, the middle portion formed by a first lateral wall and a second lateral wall protruding laterally from the vertical body, wherein the first and second lateral walls are perpendicular to the longitudinal axis. This method further involves disposing one or more fastener assemblies through one or more hole portions of the vertical frame assembly to secure the vertical frame assembly to the surface. This exemplary method further involves laterally extending a predetermined distance an extendable box member disposed between the top and bottom portions of the frame assembly. This exemplary method further involves positioning a gang box member mounted on a surface of the extendable box member, the box member located away from the vertical body, the gang box having an open end forming a plane that is parallel to the longitudinal axis of the vertical frame assembly, the gang box positioned in a predetermined location as measured by extending the box member. One of ordinary skill in the art would recognize that the predetermined locations are typically set to meet construction codes.

One embodiment of the method for placing a gang box on a wall structure involves the extendable box member being moved laterally away from the vertical body by axially rotating an upper screw member and a lower screw member disposed perpendicularly to the longitudinal axis of the frame assembly and aligned with the first lateral wall and the second lateral wall.

One embodiment of the method for placing a gang box on a wall structure involves the laterally extendable box member being substantially two inches in width and being laterally extended up to one and a half inches from the vertical body.

One embodiment of the method for placing a gang box on a wall structure involves one or more cable tie assemblies being used to attach at least one wire assembly to at least one loop or clip assembly on the vertical frame assembly. One of ordinary skill in the art would recognize that many types of wire could be used.

In another embodiment of the mounting guide for placing a gang box on a wall structure, an elongate, horizontal frame assembly has a longitudinal axis with a horizontal body with a proximal portion and distal portion, a substantially proximal vertical portion substantially perpendicular to the longitudinal axis and extending from a distal end of the proximal portion of the frame assembly and a substantially perpendicular distal vertical portion extending from a proximal end of the distal portion of the frame assembly, the distal vertical portion and the proximal vertical portion extending laterally at a substantially uniform width, a distal face of the proximal vertical portion opposite a proximal face of the distal vertical portion. A middle portion of the frame assembly is disposed between the distal vertical portion and the proximal vertical portion and parallel and substantially offset or disposed laterally from the distal portion and proximal portion of the frame assembly. One or more hoop or clip assemblies is disposed on the frame assembly designed to secure at least one wire assembly. One or more hole portions is disposed through the frame assembly designed to receive a fastener assembly therethrough. One of ordinary skill in the art would recognize that this embodiment provides a horizontal orientation for the inventive concept. In this embodiment, a support attachment may be used to mount a gang box to the inventive concept to reflect the downward pull of gravity on the gang box when the inventive concept is in a horizontal orientation.

In one embodiment of the mounting guide for placing a gang box on a wall structure, this embodiment also being a horizontally oriented embodiment of the inventive concept, a paddle fan box or other type of box holding electrical wires may be attached to the frame assembly.

A gang box is a metal or plastic box used to securely hold electrical components. In electrical work, a gang box is a metal or polymer box used to securely hold electrical components. One of ordinary skill in the art would recognize many types of gang boxes such as a round box for ceiling light fixtures, smoke alarms, carbon monoxide detectors and wall sconce light fixtures, a single-gang box for a typical outlet or switch, and a double-gang box for two light switches together in the same box, or two duplex receptacle outlets. Boxes may go by other names such as vanity boxes and pancake boxes. Gang boxes may also be 3-gang boxes, 4-gang boxes, 5-gang boxes and possibly other numerical variations. The inventive concept may be designed to fit these or other metal or polymer boxes for containing at least one wire assembly.

In electrical work, a gang box is a metal or plastic box used to securely hold electrical components and may be termed a receptacle because the gang box serves as a receptacle for electrical components.

There may be provided within the inventive concept a wire spacing and bracing management system for use in residential and commercial construction that reduces installation time while meeting code regulations for electrical installations. It would be advantageous to have a mounting guide for placing a gang box on a wall structure that is adjustable and easily configurable to accommodate the existing structure. A wall structure may also be a support structure. Furthermore, it would also be advantageous to have a mounting guide for placing a gang box on a wall structure that is easily mountable, removable, and durable should it need to be moved.

A fastener for the embodiments herein is a hardware component that mechanically joins or affixes two or more objects together. In general, fasteners are used to create non-permanent joints that can be removed or dismantled without damaging the joining components. Fasteners may be made of steel, substantially stainless steel, carbon steel, or alloy steel as might be a nail, screw, nut and bolt, pin, snap-fastener, or other components. One of ordinary skill in the art would recognize alternative methods of joining materials that could be used for the inventive concept, including crimping, welding, soldering, brazing, taping, gluing, cementing, or the use of other adhesives.

A cable tie is a type of fastener for holding items together, primarily electrical cables or wires. Because of their low cost and ease of use, cable ties are ubiquitous, finding use in a wide range of other applications. A zip tie is a type of cable tie.

One embodiment of the mounting guide for placing a gang box has the mounting configured to aid in the placement and mounting of a gang box for a switch or outlet. The guide, an extendable box member, is generally configured to allow a user to install gang boxes at the proper spacing adjacent to door jambs and onto a stud. The guide may include an adjustable mounting portion configured for extension in a direction outward and opposite the placement from a distance of approximately two (2) inches to three and one-half (3½) inches. The mounting portion in this embodiment includes an adjustment screw to generally adjust the extension of the mounting portion. One of ordinary skill in the art would recognize that other items may be used beside adjustment screws to effect the extension and retraction of the box member, for illustration, a rail member with notches set at predetermined distances. The inventive concept in this embodiment is provided in a symmetrical assembly and configured to work on either the left side or the right side of the stud the device is placed upon.

The mounting portion of the mounting guide for placing a gang box further may include nail slots allowing a user to apply the gang box to the laterally extendable box. The mounting guide for placing a gang box may be configured for the installation and attachment of single, double, triple, and other sizes of gang boxes. A pair of opposed ends of the mounting guide for placing a gang box include an aperture for the placement of a fastener to allow for attachment of the mounting guide for placing a gang box to the stud. These ends further include a plurality of loops to allow for the fastening of wire, such as has a clip suitable for a metal clad wiring bundles as illustrated by Romex style wire holders secured by zip ties.

It would be advantageous to have a mounting guide for placing a gang box that is a guide for installing a gang box in a desired position. Furthermore, it would be advantageous to have a mounting guide for placing a gang box that provides at least one nail slot for installing the gang box. Still further, it would be advantageous to have a mounting guide for placing a gang box that offers hoops to allow for the fastening, preferably through a zip tie, of the associated wires for installation.

The inventive concept advantageously fills the aforementioned deficiencies by providing a mounting guide for gang box placement, which provides a guide and holder for the gang box during installation. The inventive concept fulfills the need for users to follow installation or construction codes. Among other things, it is an advantage of the inventive concept to provide a mounting gang box guide for switches and outlet placement that does not suffer from problems or deficiencies associated with prior solutions. It is still further an advantage of the inventive concept to work for single and multi-gang boxes. Still further, the inventive concept may have an extendable guide configured to adjust the distance between the gang box and door jamb/stud during installation.

In one embodiment of the inventive concept, a mounting guide for placing a gang box is generally provided in a short version and a tall version, generally providing a pair of predetermined heights for the placement of the receptacle box. The mounting guide for placing a gang box in this embodiment includes a first end having a foot configured to offer resting support for the inventive concept on a floor surface. A second end extends a height opposite the first end and culminates in a position generally parallel and co-planar to the first end. The mounting guide for placing a gang box in this embodiment may have a receptacle securing portion generally positioned at the predetermined height for the installation of the receptacle and configured to enable the securing of the receptacle to the device. Preferably, the receptacle securing portion is configured by a jog or lateral extension of the mounting guide for placing a gang box wherein the mounting guide for placing a gang box extends perpendicular to the first end at a first height and extends a width, generally corresponding to the width of a receptacle, extends parallel to the first end to a second height, generally corresponding to the height of the receptacle to form the middle portion of the vertical frame assembly, and returns perpendicularly back a width parallel to the first jog, and then extends coplanar with the first end and culminating in the second end, wherein the device may, in this embodiment, be comprised of a single molded device having a shape for the securing of the receptacle as described in previous embodiments. A second end in this embodiment includes an aperture for the placement of a fastener such as a nail centrally located on the second end and configured to allow the mounting guide for placing a gang box to be secured adjacent to a stud. Along the mounting guide for placing a gang box height in this embodiment of the mounting guide for placing a gang box, a plurality of loops and clips are enabled to secure wires to the device after or prior to placement into the receptacle. Preferably, the short version has a clip suitable for a metal clad wiring bundle such as Romex style wire holders, and the tall version contains loops for securing wiring. The receptacle portion generally receives the receptacle by clipping to a nail of the receptacle or through a friction fit. The receptacle portion may be provided in an assembly for a single box receptacle or multiple box assembly.

The inventive concept now will be described more fully hereinafter with reference to the accompanying drawings, which are intended to be read in conjunction with both this summary, the detailed description, and any preferred and/or particular embodiments specifically discussed or otherwise disclosed. This inventive concept may, however, be embodied in many different forms and should not be construed as limited to the embodiments set forth herein; rather, these embodiments are provided by way of illustration only and so that this disclosure will be thorough, complete, and will fully convey the full scope of the inventive concept to those skilled in the art.

### BRIEF DESCRIPTION OF THE DRAWINGS

FIG. 1 illustrates a rear view of a mounting guide for placing a gang box with the laterally extendable box member.

FIG. 2 illustrates a front view of the mounting guide for placing a gang box with the laterally extendable box member.

FIG. 3 illustrates the left side view of the mounting guide for placing a gang box with the laterally extendable box member.

FIG. 4 illustrates the left side view of the mounting guide for placing a gang box with the laterally extendable box member in an extended position.

FIG. 5 illustrates the right side view of the mounting guide for placing a gang box with the laterally extendable box member.

FIG. 6 illustrates the right side view of the mounting guide for placing a gang box with the laterally extendable box member with a gang box.

FIG. 7 illustrates a perspective view of the mounting guide for placing a gang box with the laterally extendable box member when in an extended position along with fastener and cable tie assemblies.

FIG. 8 illustrates a perspective view of the mounting guide for placing a gang box.

FIG. 9 illustrates a perspective view of the mounting guide for placing a gang box with the laterally extendable box member with a gang box.

FIG. 10 illustrates a perspective view of another embodiment of a mounting guide for placing a gang box along with fastener and cable tie assemblies which has a tall elongate configuration designed for location on an upright stud member.

FIG. 11 illustrates a perspective view of yet another embodiment of a mounting guide for placing a gang box which has a shorter elongate configuration designed for location on an upright stud member.

FIG. 12 illustrates a second perspective view of the tall elongate mounting guide for placing a gang box.

FIG. 13 illustrates a second perspective view of the short elongate mounting guide for placing a gang box when shorter.

FIG. 14 illustrates a rear view of the tall mounting guide for placing a gang box.

FIG. 15 illustrates the rear view of the short version of the mounting guide for placing a gang box.

FIG. 16 illustrates a bottom view of the tall mounting guide for placing a gang box.

FIG. 17 illustrates a bottom view of the short version of the mounting guide for placing a gang box.

FIG. 18 illustrates a close up perspective view of the tall elongate mounting guide for placing a gang box center.

FIG. 19 illustrates a close up perspective view of the short version of the mounting guide for placing a gang box center.

FIG. 20 illustrates a close up perspective view of the tall mounting guide for placing a gang box top.

FIG. 21 illustrates a close up perspective view of the short version of the mounting guide for placing a gang box top.

FIG. 22 illustrates a close up perspective view of the tall mounting guide for placing a gang box bottom.

FIG. 23 illustrates a close up perspective view of the short version of the mounting guide for placing a gang box bottom.

FIG. 24 illustrates a close up perspective view of the tall or short mounting guide for placing a gang box within the mounting guide.

FIG. 25 illustrates the perspective view mounting guide for placing a gang box within the mounting guidecontext.

FIG. 26 illustrates a close up perspective view of the short version of the mounting guide for placing a gang box within the actual mounting guide.

FIG. 27 illustrates arear perspective view the tall mounting guide for a double gang box with an actual box located therein.

FIG. 28 illustrates a front perspective view short version of the mounting guide for placing a double gang box in context.

FIG. 29 illustrates perspective view the mounting guide for a double gang box.

FIG. 30 illustrates perspective view the short version of the mounting guide for placing a double gang box.

FIG. 31 illustrates a side view of the tall mounting guide for placing a gang box.

FIG. 32 illustrates a side view of the short version of the mounting guide for placing a gang box.

FIG. 33 illustrates the front view of the tall mounting guide for placing a gang box.

FIG. 34 illustrates the front view of the short version of the mounting guide for placing a gang box.

FIG. 35 illustrates another rear view of the tall mounting guide for placing a gang box.

FIG. 36 illustrates another rear view of the short version of the mounting guide for placing a gang box.

FIG. 37 illustrates a top view of the tall elongate mounting guide for placing a gang box.

FIG. 38 illustrates a top view of the short elongate version of the mounting guide for a gang box.

FIG. 39 illustrates a perspective view of the horizontally mounted version of the mounting guide for placing a gang box along with a paddle fan box.

FIG. 40 illustrates a method for placing a gang box using the laterally extendable box member.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

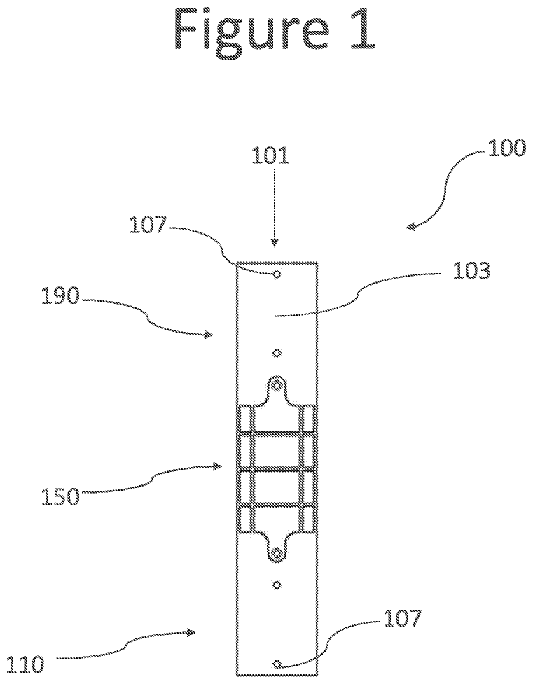

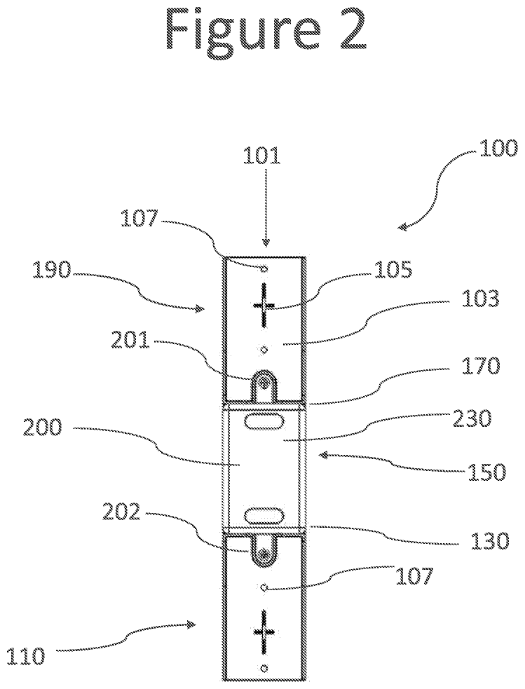

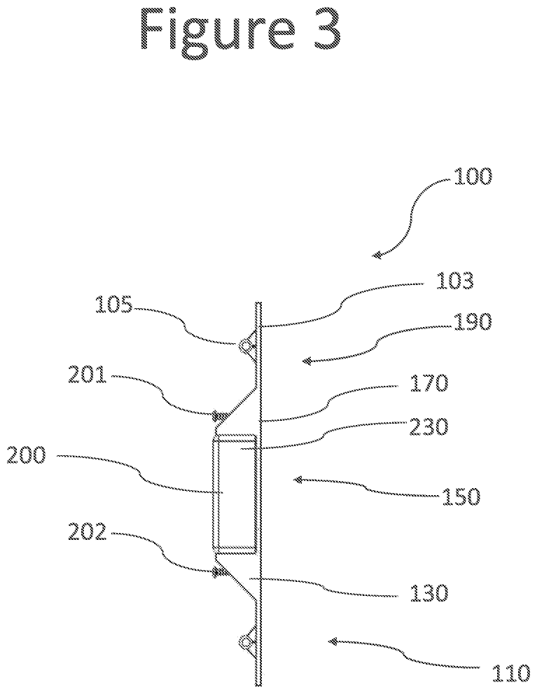

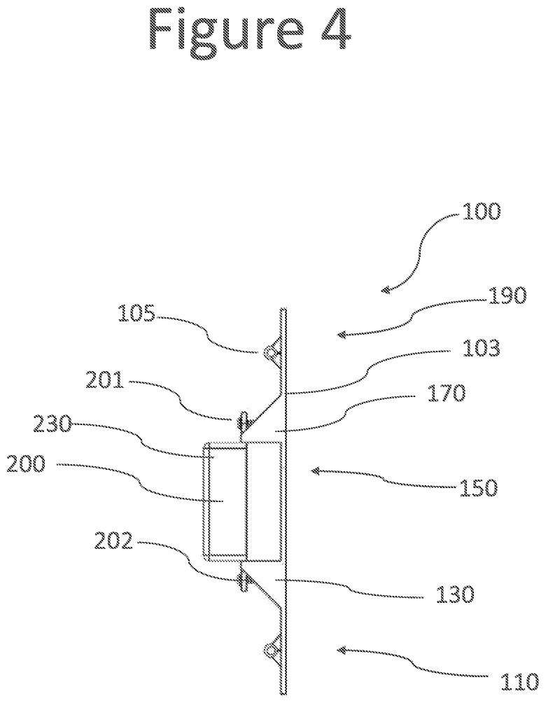

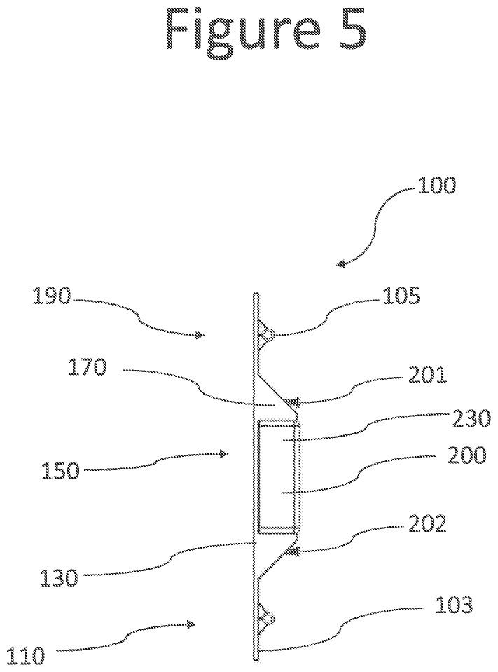

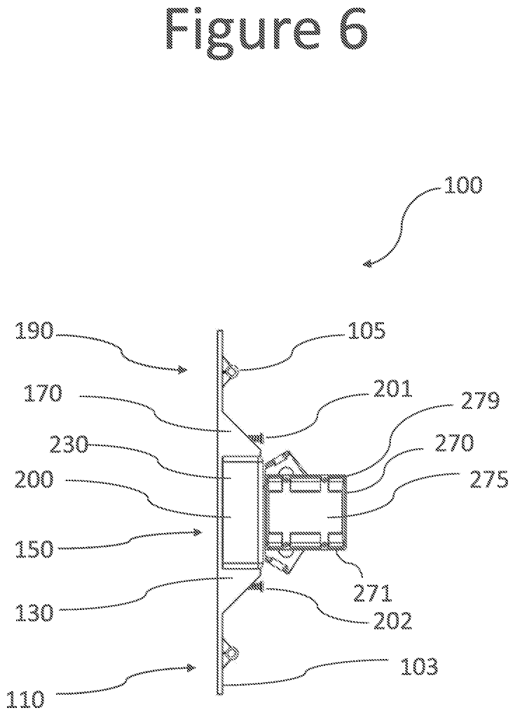

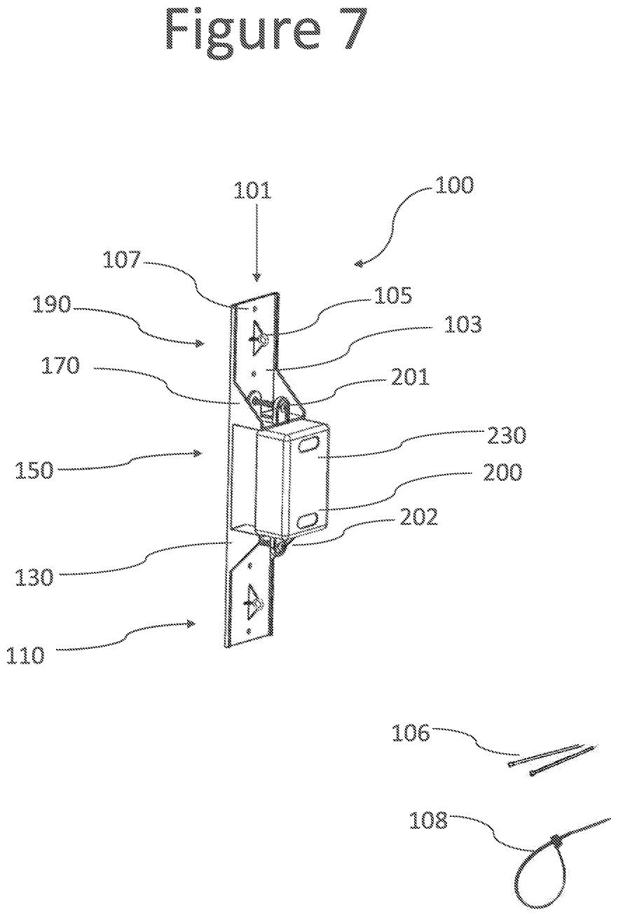

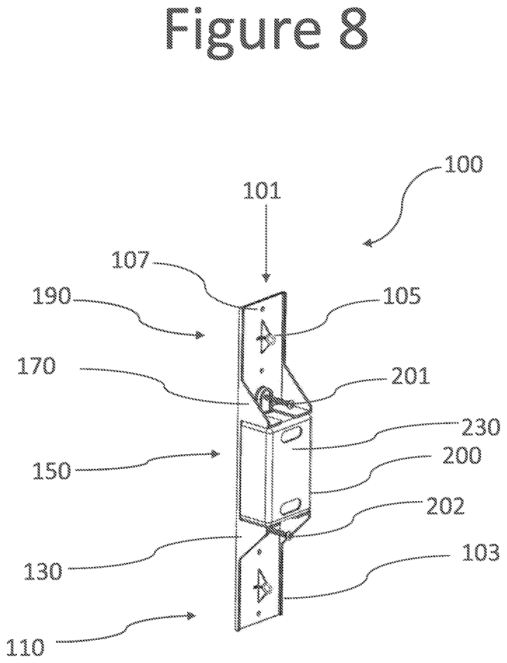

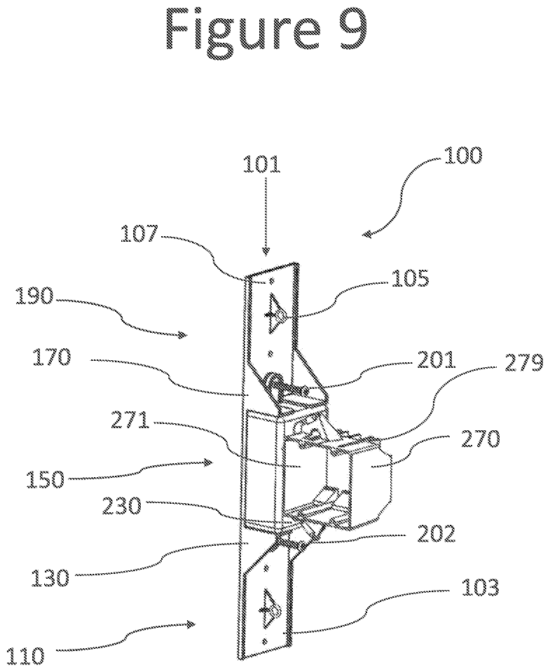

Referring to the Figures, FIGS. 1-9 illustrate the inventive concept in one embodiment is a mounting guide 10 for placing a gang box 270 on a wall or upright stud structure in a predetermined location. In this embodiment of mounting guide 10 an elongate substantially planar vertical frame assembly 100 has a longitudinal axis 101 through a vertical body 103 and has a top 190, middle 150, and bottom portion 110, the middle portion 150 formed by a first lateral wall 170 and a second lateral wall 130 protruding laterally from the vertical body 103, wherein the first and second lateral walls 170 and 130 are perpendicular to the longitudinal axis 101. A laterally extendable box member 200 is designed to be mounted within the middle portion 150 of the vertical frame assembly 100 and is disposed between the top and bottom portions 190 and 110, the extendable box member 200 designed to move laterally away from the vertical body 103 as upper and lower screw members 201, 202 that secure the box member 200 are axially rotated. The upper and lower screw members 201, 202 are perpendicular to the longitudinal axis 101 and are aligned with the first lateral wall 170 and the second lateral wall 1300. In this example embodiment, a gang box member 270 is designed to be mounted on a surface 230 of the extendable box member 200 located away from the vertical body 103, the gang box 270 having an open end 275 forming a plane that is parallel to the longitudinal axis 101 of the vertical frame assembly 100.

In this example embodiment, one or more hoop or clip assemblies 105 are disposed on the frame assembly 100 designed to secure at least one wire assembly spanning to and from the gang box member 270. One or more hole portions 107 are disposed through the frame assembly 100 designed to receive a fastener assembly therethrough. In this embodiment of the mounting guide 10 for placing a gang box 270 on a wall structure, the one or more loop or clip assemblies 105 are designed to secure the at least one wire assembly with one or more cable tie assemblies 108. In this embodiment of the mounting guide 10 for placing a gang box 270 on a wall structure, the one or more loop assemblies or clip assemblies 105 is a metal-clad wiring bundle style wire holder assembly 105B.

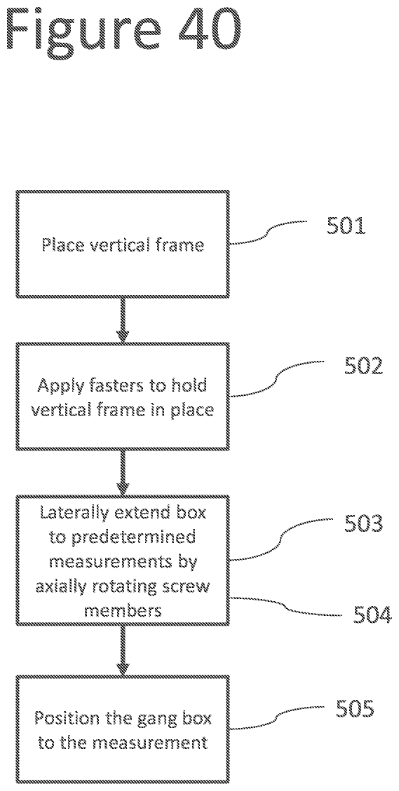

Referring again to FIGS. 1-9 and 40 there is further illustrated a method 500 for placing a gang box 270 and includes the step 501 of mounting to a surface (such as a wall stud) an elongate substantially planar vertical frame assembly 100 having a longitudinal axis 101 through a vertical body and having a top 190, middle 150 and bottom portion 110, the middle portion 150 formed by a first lateral wall 170 and a second lateral wall 130 protruding laterally from the vertical body 103, wherein the first and second lateral walls 170 and 130 are perpendicular to the longitudinal axis 101. This method 500 further involves the step 502 of disposing one or more fastener assemblies 106 through one or more hole portions 107 of the vertical frame assembly 100 to secure the vertical frame assembly 100 to the surface, such as a wall structure or an upright wall stud. This method further involves the step 503 of laterally extending a predetermined distance of an extendable box member 200 disposed between the top and bottom portions 190, 110 of the frame assembly 100. This method further involves the step 505 of positioning a gang box member 270 mounted on a surface of the extendable box member 230, the box member 200 located away from the vertical body 103, the gang box 270 having an open end 271 forming a plane that is parallel to the longitudinal axis 101 of the vertical frame assembly 100, the gang box 270 positioned in a predetermined location as measured by extending the box member 200. This embodiment of the method 500 for placing a gang box 270 involves the step 504 of the extendable box member 200 being moved laterally away from the vertical body 103 by axially rotating 504 an upper screw member 201 and a lower screw member 202 disposed perpendicularly to the longitudinal axis 101 of the frame assembly 100 and aligned with the first lateral wall 130 and the second lateral wall 270. This embodiment of the method 500 for placing a gang box 270 may further involve the step 503 of laterally extendable box member 200 being substantially two inches in width and being laterally extended up to, but not necessarily limited to, one and a half inches from the vertical body. This embodiment of the method for placing a gang box 270 further involves one or more cable tie assemblies 108 being used to attach at least one wire assembly to a loop or clip assembly 105 on the vertical frame assembly 100.

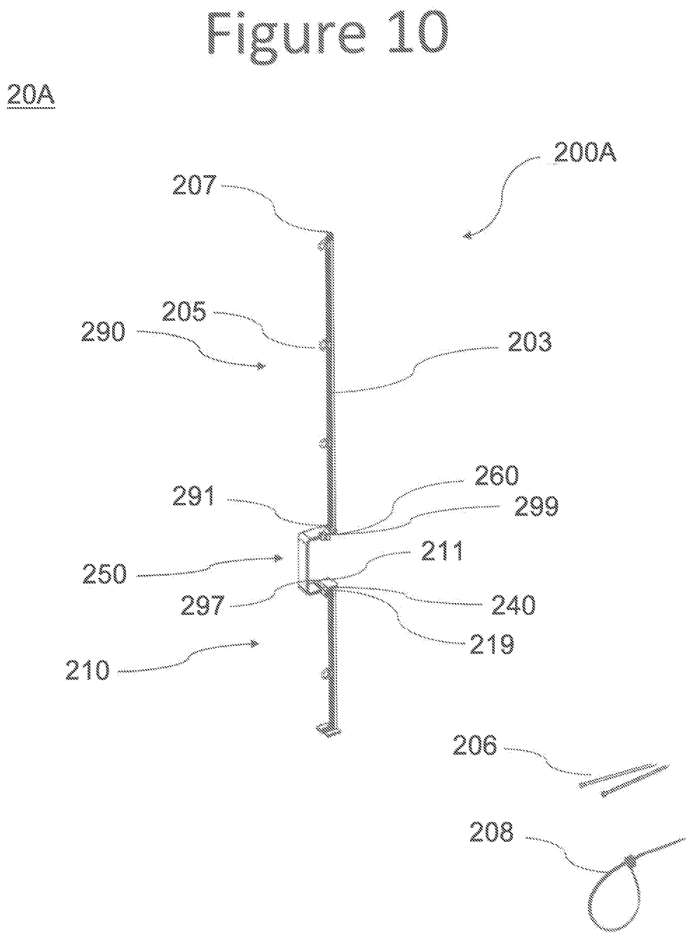

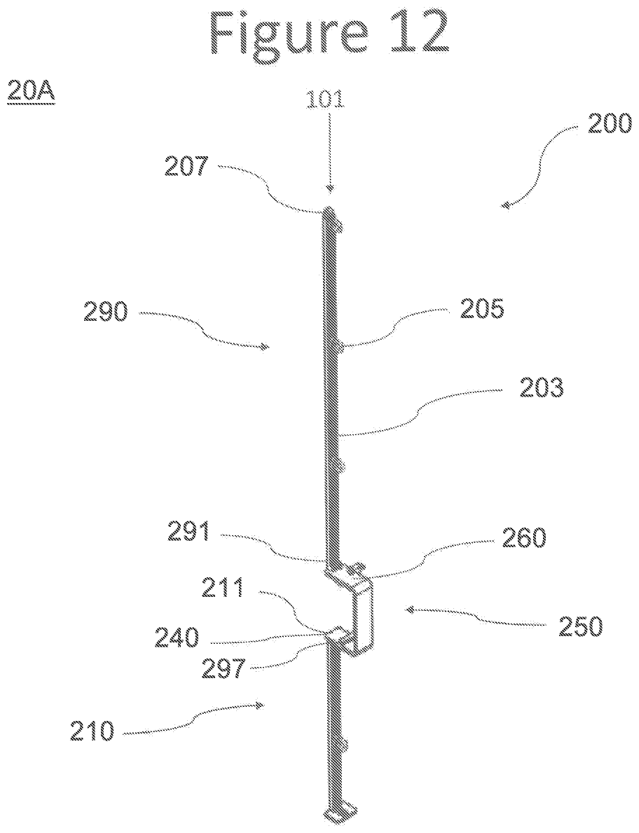

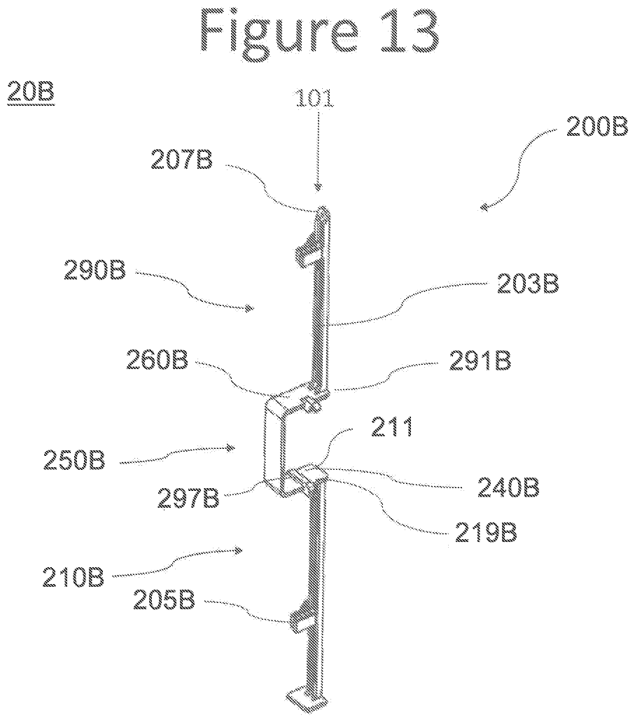

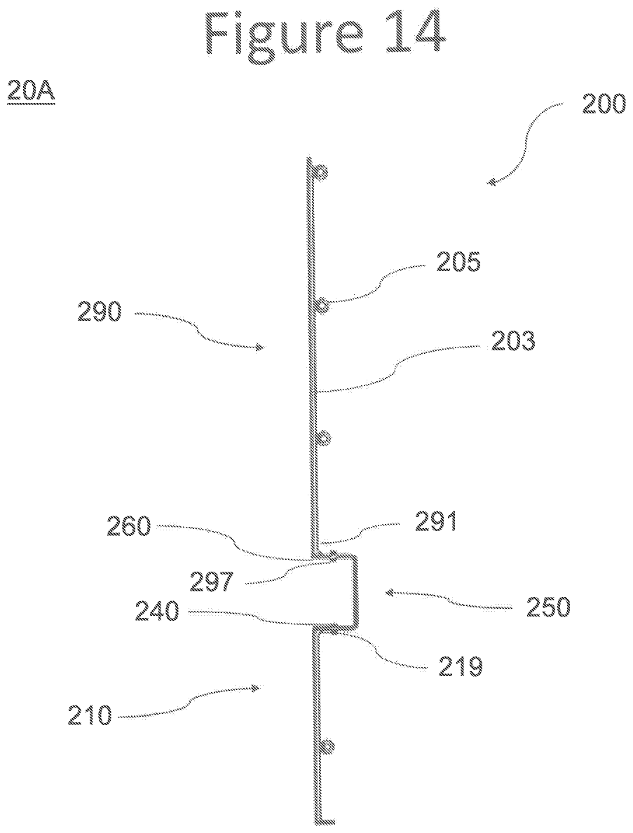

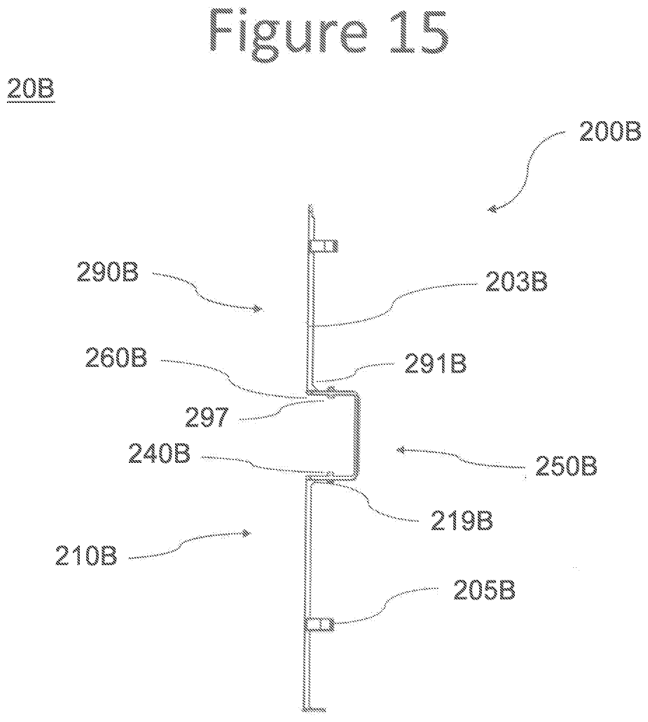

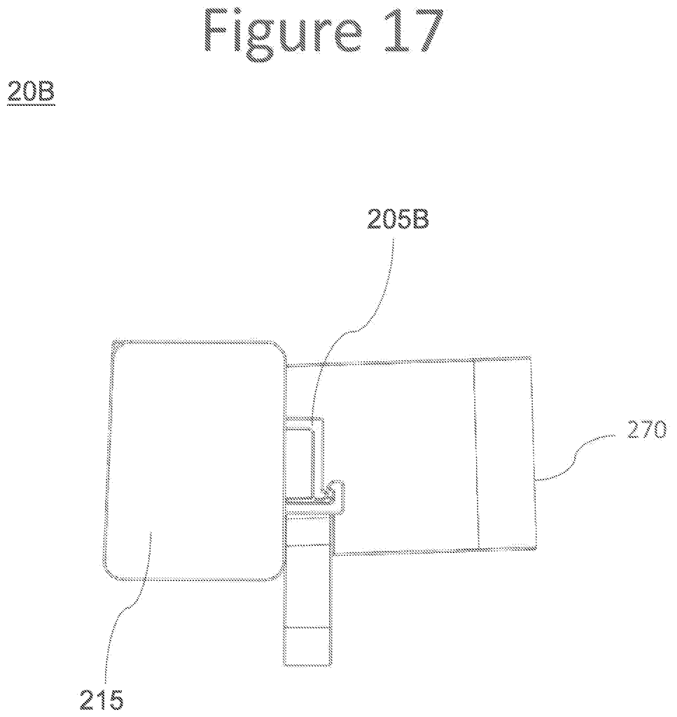

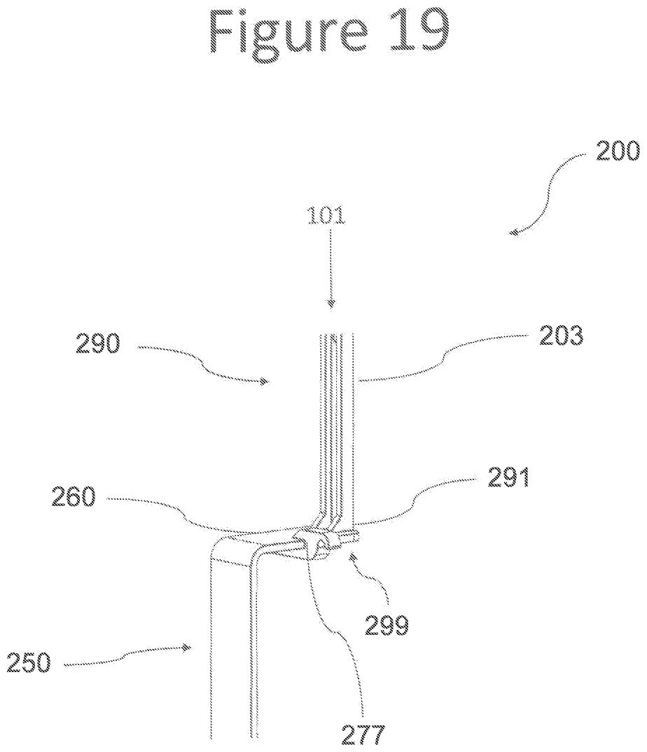

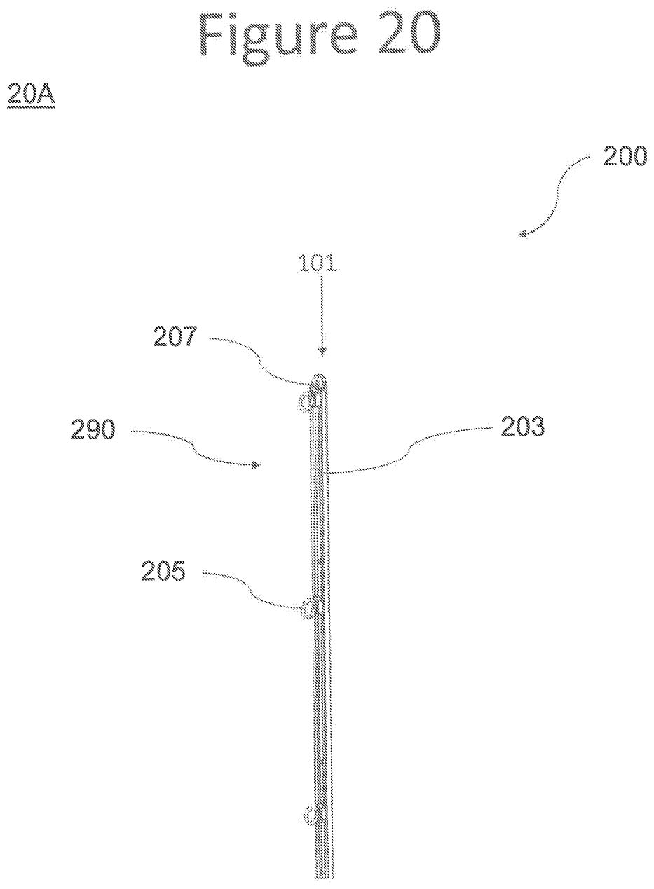

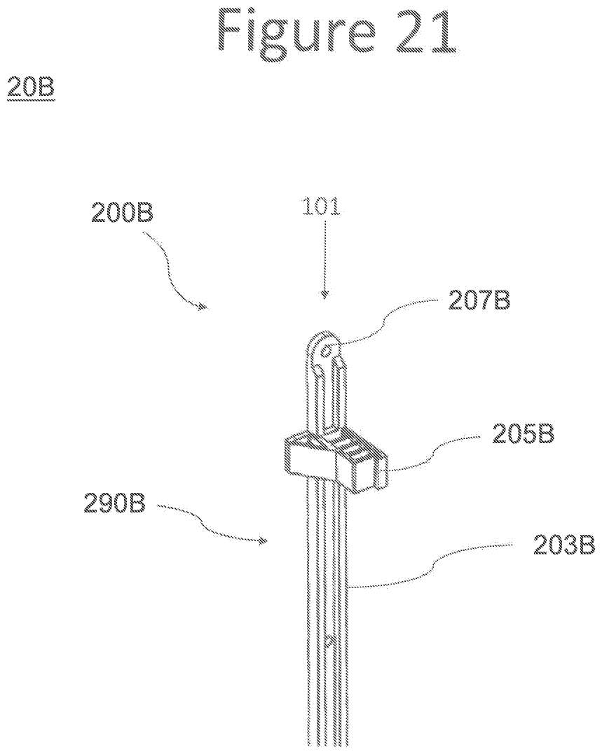

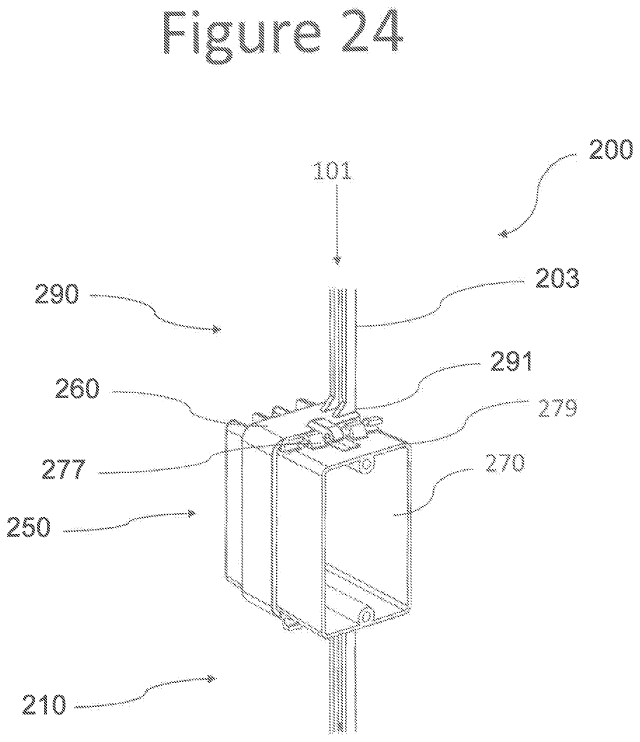

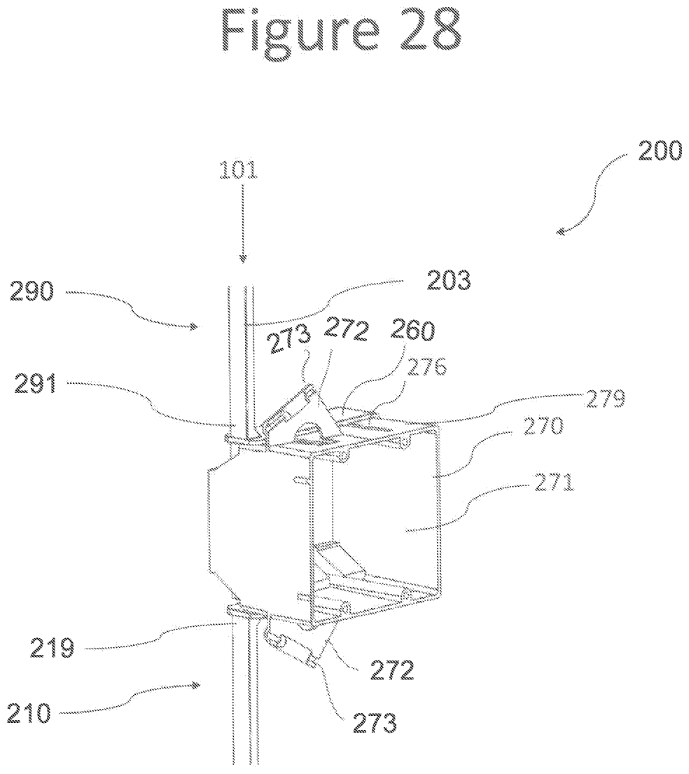

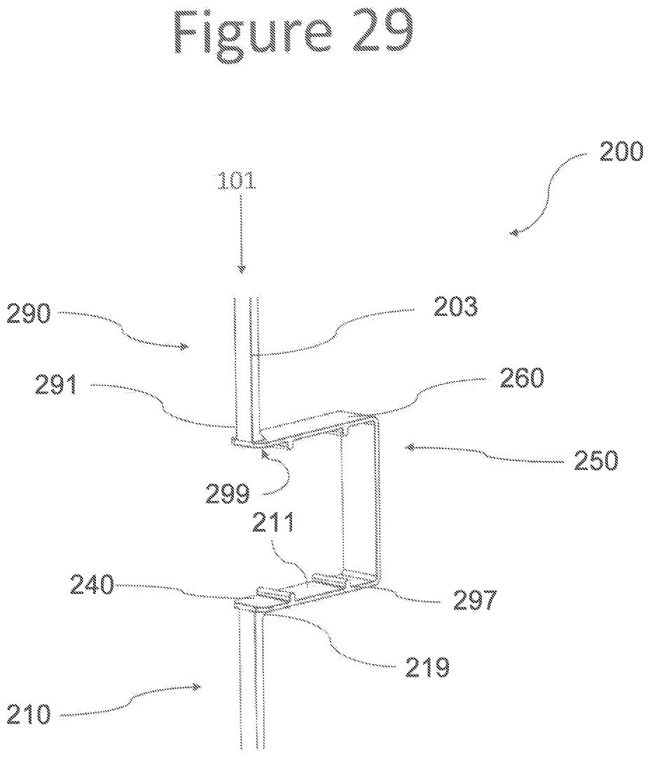

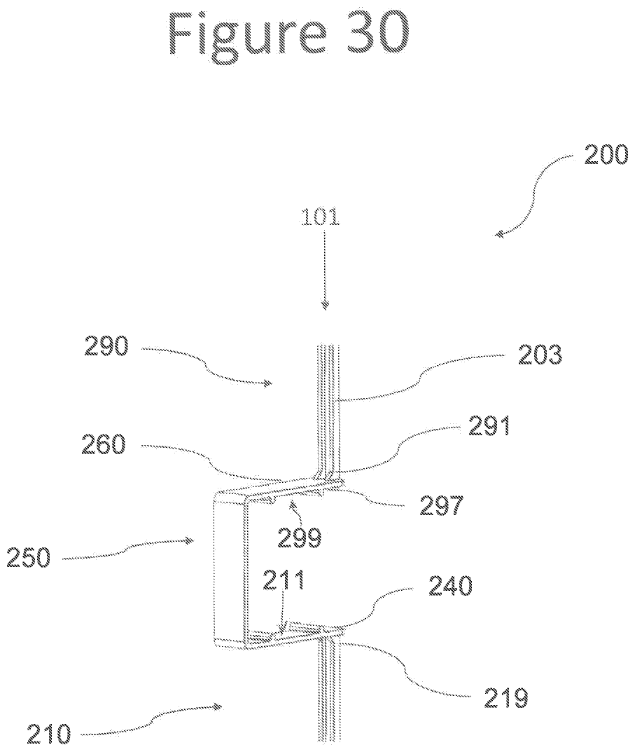

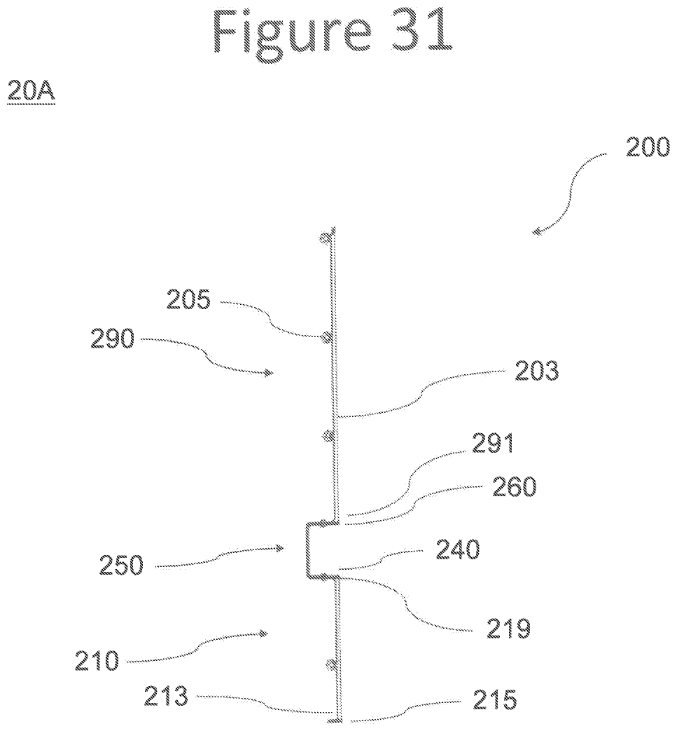

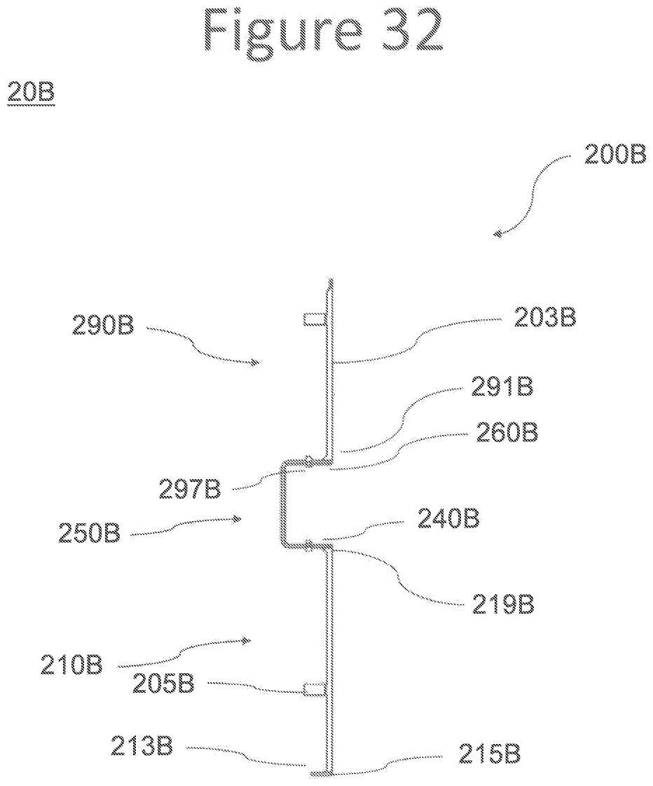

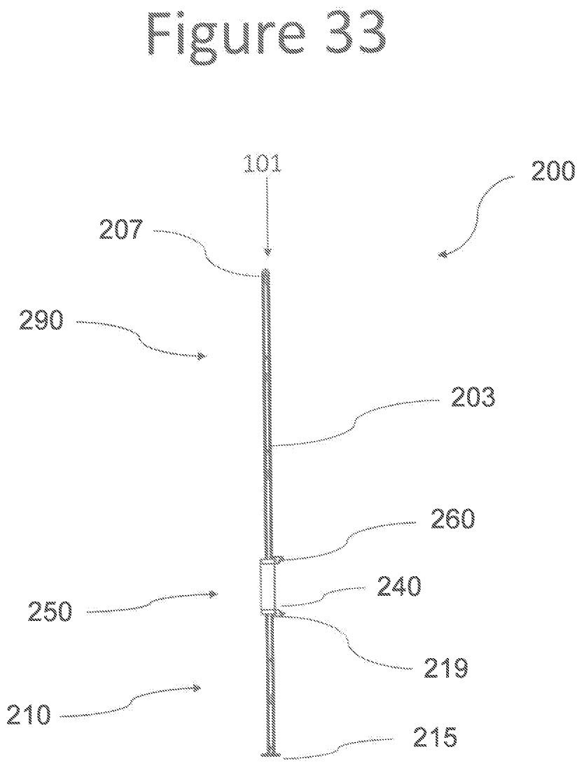

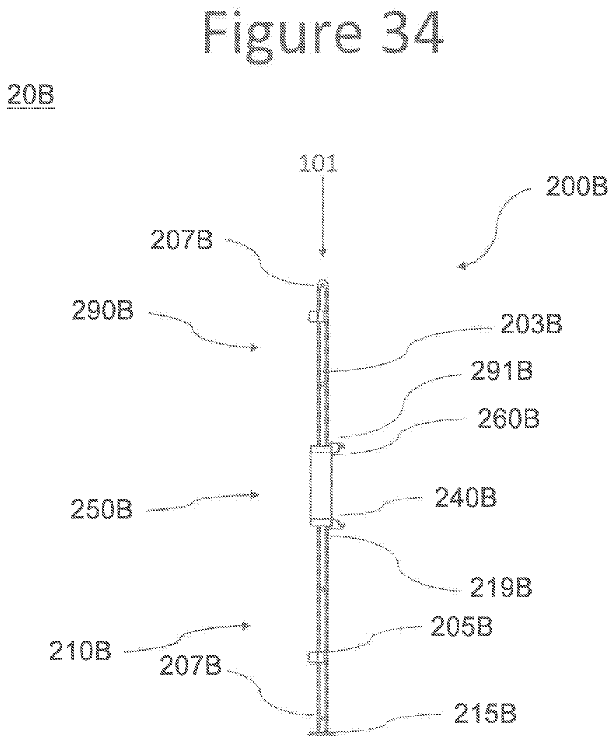

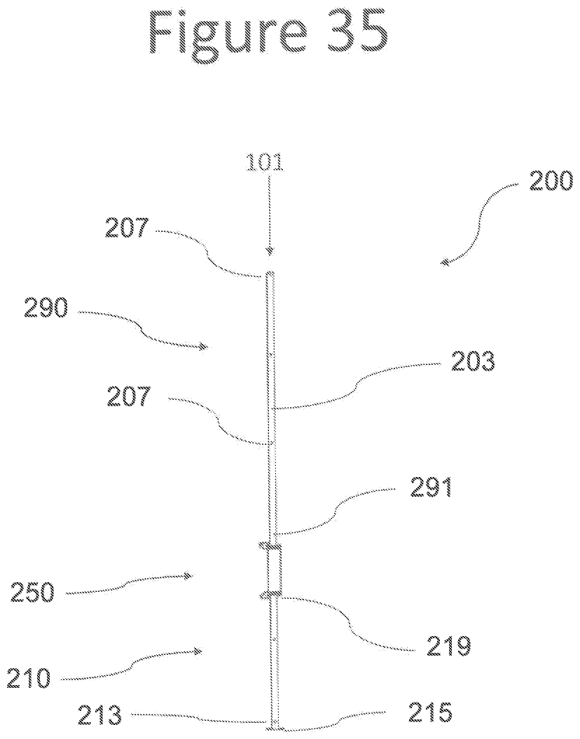

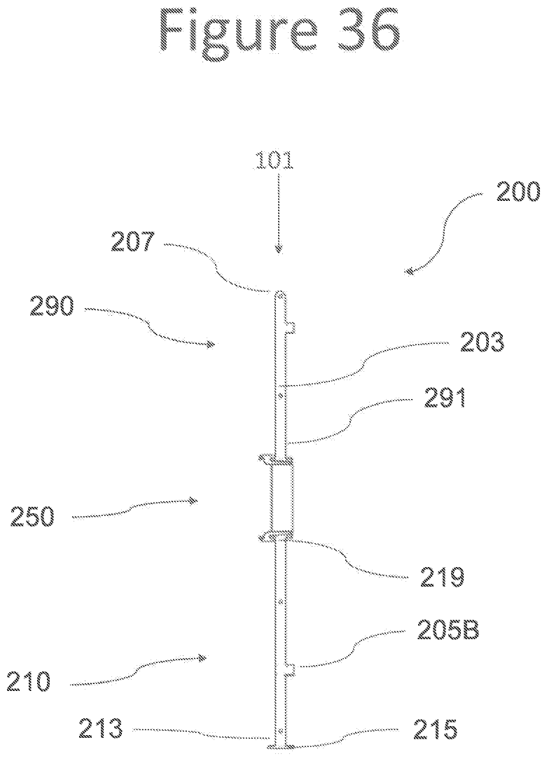

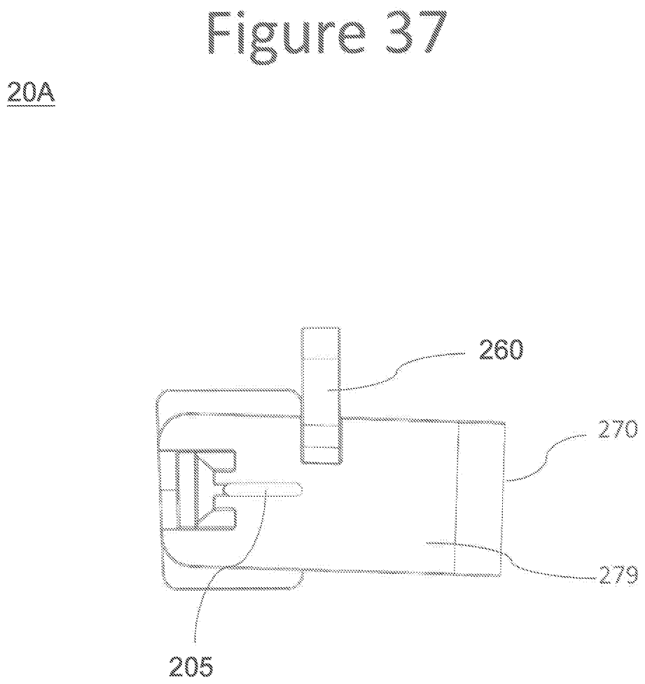

Referring now to FIGS. 10-38, there is illustrated two related embodiments of elongate mounting guides 20A and 20B, including a tall member 200 and a short member 200B, for placing a gang box 270 on a wall structure where the lower portion 210 of the frame assembly 200 is substantially ten inches in height but not necessarily limited to such a height. In these embodiments of the mounting guide 20A and 20B for placing a gang box 270 on a wall structure, the upper portion of the frame assembly 200 is substantially eight inches (20B) or substantially twenty inches in height (20A) but are not necessarily limited to such dimensions and can be reconfigured to suit the needs of the construction project. For ease of description, common elements are shown in the figures and will be repeated or referenced for clarity.

Referring to FIGS. 10, 12, 14, 16, 18-20, 24, 25, 27-31, 33, 35 and 37 and with reference primarily to mounting guide 20A-15 and 16-38, there is illustrated tall mounting guide tall 20A for placing a gang box 270 on a wall structure that has an elongate, vertical frame assembly 200 having a longitudinal axis 101 with an elongate vertical body 203 with an upper portion 290 and lower portion 210 and a center portion 250. Center portion 250 is formed from a lower horizontal planar portion 240 substantially perpendicular to the longitudinal axis 101 and extending from a top end 219 of the lower portion 210 of the frame assembly 200A and an upper horizontal portion 260 substantially perpendicular to axis 101 and extending from a bottom end 291 of the upper portion 290 of the frame assembly 200, the upper horizontal portion 290 and the lower horizontal portion 210 extending laterally at a substantially uniform width, an upper face 211A of the lower horizontal portion 211 opposite a lower face 299A of the upper horizontal portion 299. A middle or center portion of the frame assembly 120 is disposed between the upper horizontal portion 260 and the lower horizontal portion 240 and parallel and substantially offset or disposed laterally from the upper portion 290 and lower portion 210 of the frame assembly 200. One or more hoop or clip assemblies 205 is disposed on the frame assembly 200 designed to secure at least one wire assembly. One or more hole portions 207 is disposed through the frame assembly 200 designed to receive a fastener assembly 206 therethrough. In this embodiment of the mounting guide 20A for placing a gang box 270 on a wall structure includes one or more loop or clip assemblies 205 are designed to secure the at least one wire assembly with one or more cable tie assemblies 208. In this embodiment of the mounting guide for placing a gang box 270 on a wall structure, the one or more loop assemblies or clip assemblies 205 may be a metal-clad wiring bundle style wire holder assembly 205B.

In this example embodiment of the mounting guide 20A is configured for placing a gang box 270 on a wall structure where one or more loop or clip assemblies 205 are spaced substantially six inches from the top end 219 of the lower portion 210 of the frame assembly 200 or the bottom end 291 of the upper portion 290 of the frame assembly 200. In a related embodiment, center portion 250 is formed as a sliding u-shaped bracket that moves up and down vertically along elongate frame 200A so that the user can place the gang box member at any desired height from the floor.

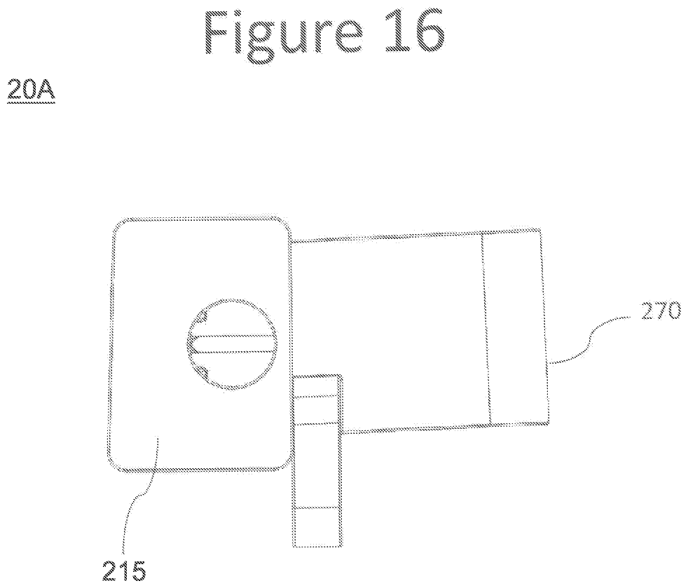

In this example embodiment, there is provided mounting guide 20A (and similarly 20B below) for placing a gang box 270 on a wall structure (see FIGS. 16, 24, 25, 27, 28 and 37) wherein lower horizontal portion 240 (substantially perpendicular to axis 101) extending from the top end 219 of the lower portion 210 of the frame assembly 200 and the upper horizontal portion 260 (perpendicular to axis 101) extending from the bottom end 291 of the upper portion 290 of the frame assembly 200, the upper horizontal portion 260 and the lower horizontal portion 240 extending laterally a substantially uniform width, are configured to enable the securing of the gang box 270 to the frame assembly 200.

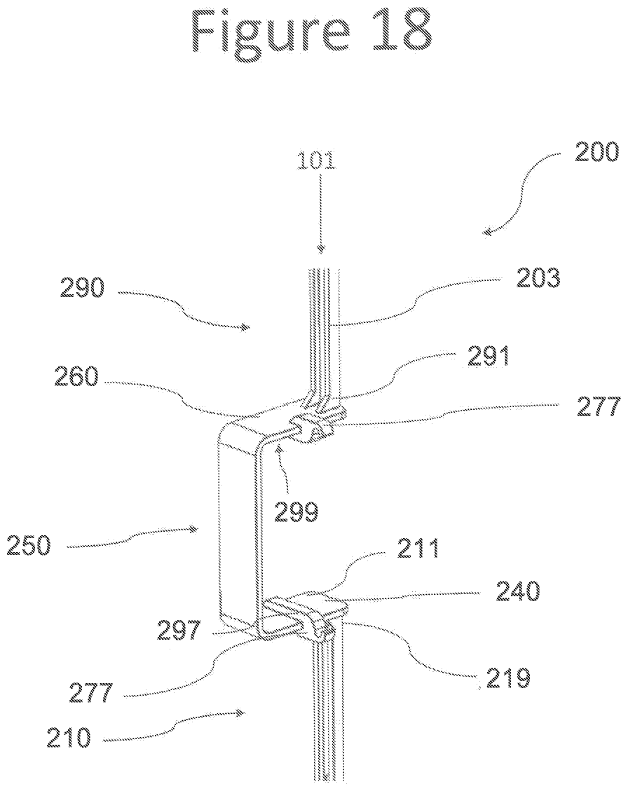

FIGS. 18, 19, and 24 illustrate one embodiment of the mounting guide 20A for placing a gang box 270 on a wall structure wherein at least one clip and hook assembly 277 is coupled to the lower horizontal portion 20 and the upper horizontal portion 260 of the frame assembly 200 and designed to secure the gang box assembly 270, the gang box assembly 270 held substantially in place by the lower horizontal portion 240 and the upper horizontal portion 260.

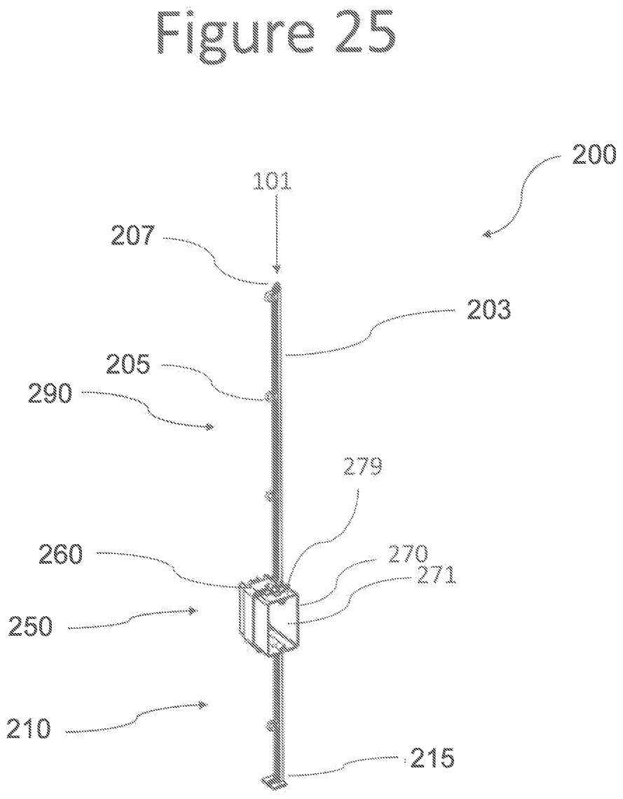

FIGS. 25, and 27-28 illustrate an embodiment of the mounting guide 20A for placing an actual gang box 270 (within middle portion 250) on a wall structure wherein the spacing between the lower horizontal portion 240 and the upper horizontal portion 260 is substantially equal to the vertical height of the mounted gang box assembly 270, the lower horizontal portion 240 and the upper horizontal portion 260 designed to couple substantially contiguously to a bottom portion of the gang box assembly 271 and a top portion of the gang box assembly 279 to hold the gang box assembly 270 substantially in place.

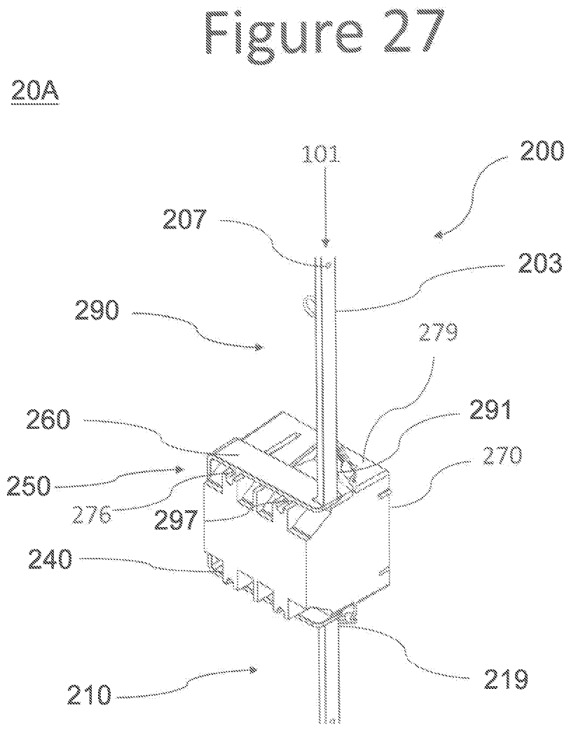

FIGS. 27, 28, 29, and 30 illustrate one embodiment of the mounting guide 20A for placing an actual gang box 270 on a wall structure wherein one or more protrusions 297 are disposed on the upper face 211 of the lower horizontal portion 240 of the frame assembly 200 and the lower face 299 of the upper horizontal portion 260 of the frame assembly 200 and designed to prevent the gang box assembly 270 from sliding outward from the lower horizontal portion 240 and the upper horizontal portion 260 of the frame assembly 200 by coupling to corresponding groove portions 276 of the gang box assembly. Gang box member 270 also includes securing tabs 272 that protrude upward and include a channel 273 for driving a nail into the wall stud for securing the gang box 270.

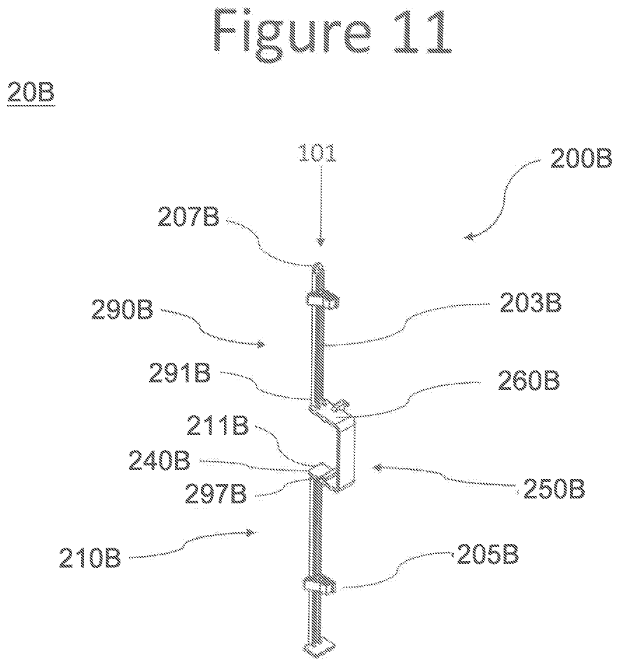

Referring now to FIGS. 11, 13, 15, 17, 21-23, 26, 32, 34, 36 and 38 and mounting guide 20B, there is illustrated tall mounting guide tall 20B for placing a gang box 270 on a wall structure that has an elongate, vertical frame assembly 200B having a longitudinal axis 101 with an elongate vertical body 203B with an upper portion 290B and lower portion 210B and a center portion 250B. Center or middle portion 250B is formed from a lower horizontal planar portion 240B substantially perpendicular to the longitudinal axis 101 and extending from a top end 219B of the lower portion 210B of the frame assembly 200B and an upper horizontal portion 260B substantially perpendicular to axis 101 and extending from a bottom end 291B of the upper portion 290B of the frame assembly 200B, the upper horizontal portion 290B and the lower horizontal portion 210B extending laterally at a substantially uniform width, an upper face of the lower horizontal portion 211B opposite a lower face of the upper horizontal portion 299B. A middle or center portion of the frame assembly 220B is disposed between the upper horizontal portion 260B and the lower horizontal portion 240B and parallel and substantially offset or disposed laterally from the upper portion 290B and lower portion 210B of the frame assembly 200B. One or more hoop or clip assemblies 205B is disposed on the frame assembly 200B designed to secure at least one wire assembly. One or more hole portions 207B is disposed through the frame assembly 200B designed to receive a fastener assembly 206 therethrough. In this embodiment of the mounting guide 20B for placing a gang box 270 on a wall structure includes one or more loop or clip assemblies 205B are designed to secure the at least one wire assembly with one or more cable tie assemblies 208. In this embodiment of the mounting guide for placing a gang box 270 on a wall structure, the one or more loop assemblies or clip assemblies 205 may be a metal-clad wiring bundle style wire holder assembly 205B.

In this example embodiment of the mounting guide 20B is configured for placing a gang box 270 on a wall structure where one or more clip assemblies 205B are spaced substantially six inches from the top end 219B of the lower portion 210B of the frame assembly 200B or the bottom end 291B of the upper portion 290B of the frame assembly 200B.

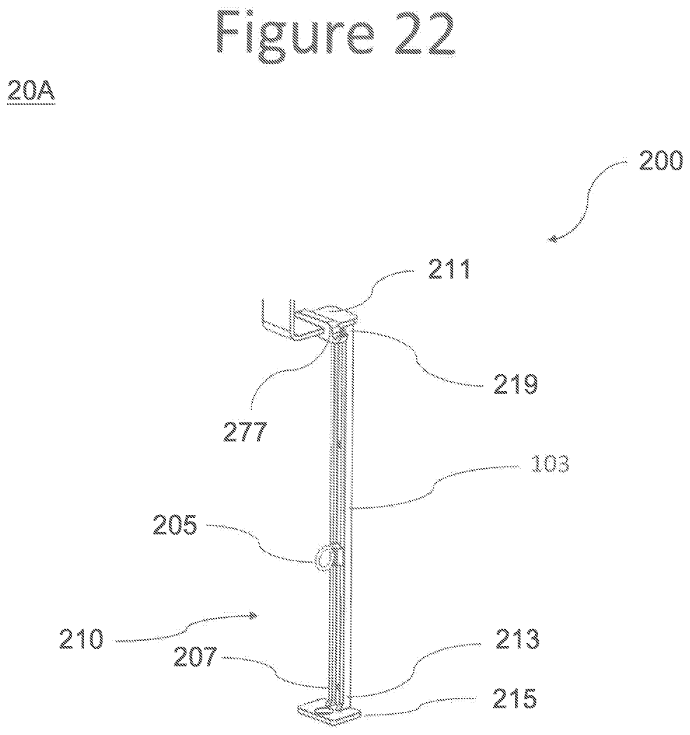

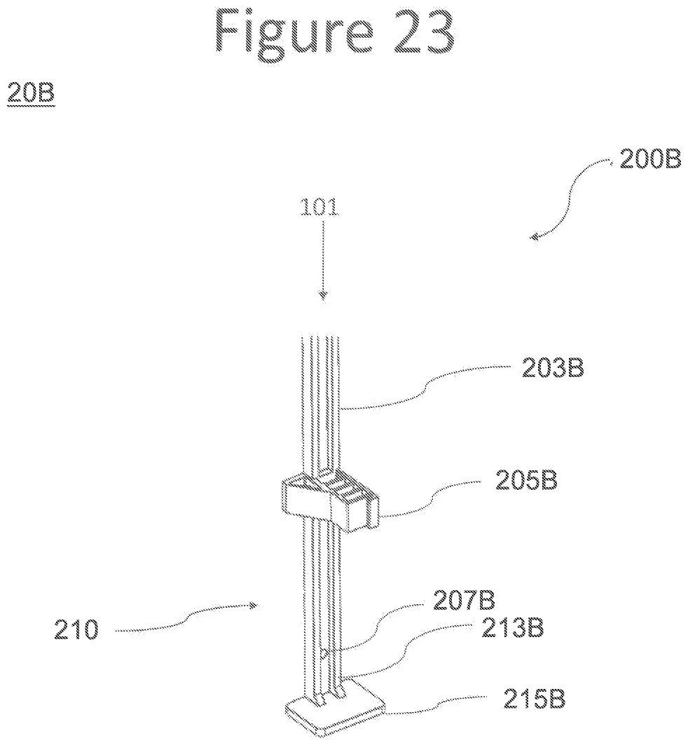

Specifically referring to FIGS. 22-23, there is illustrated a substantially horizontally planar foot portion 215 that is coupled to a bottom end 213 of the lower portion 210 of the frame assembly 200B, the frame assembly 200B designed to rest on the foot portion 215 when the foot portion 215 is disposed on a surface, the lower portion 210 extending upward from the foot portion 215 a predetermined height for the placement of the gang box 270 between the upper horizontal portion 260B and the lower horizontal portion 240B of the frame assembly 200B.

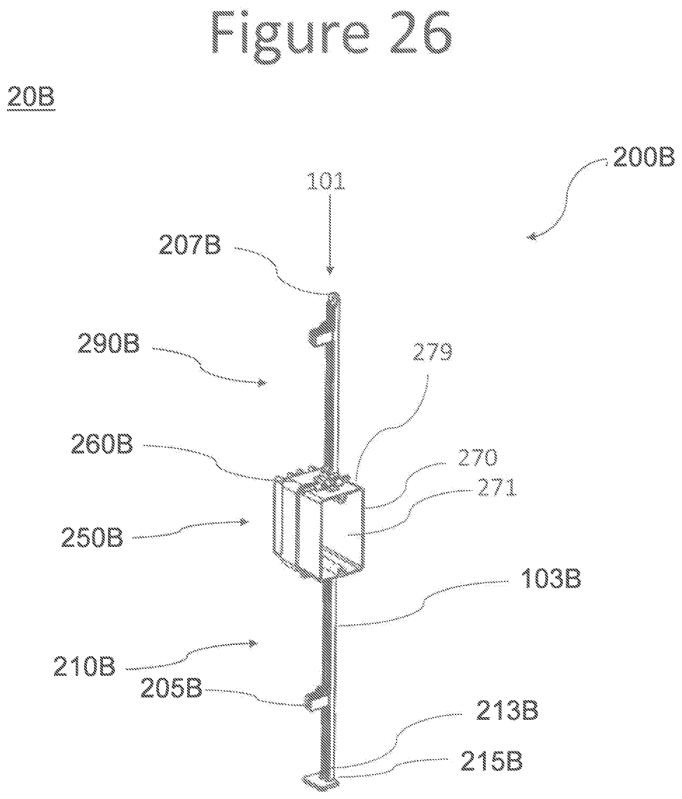

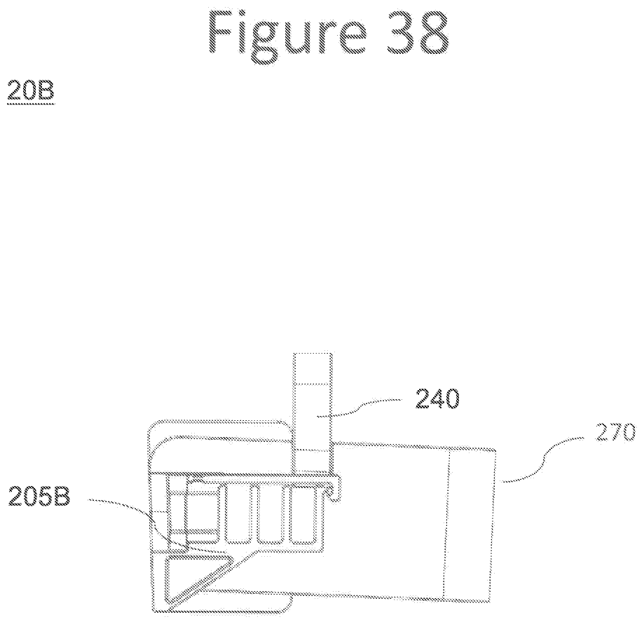

Referring now to FIGS. 26 and 38, there is illustrated an embodiment of the mounting guide 20B for placing an actual gang box 270 (within middle portion 250B) on a wall structure wherein the spacing between the lower horizontal portion 240B and the upper horizontal portion 260B is substantially equal to the vertical height of the mounted gang box assembly 270, the lower horizontal portion 240B and the upper horizontal portion 260B designed to couple substantially contiguously to a bottom portion of the gang box assembly 271 and a top portion of the gang box assembly 279 to hold the gang box assembly 270 substantially in place.

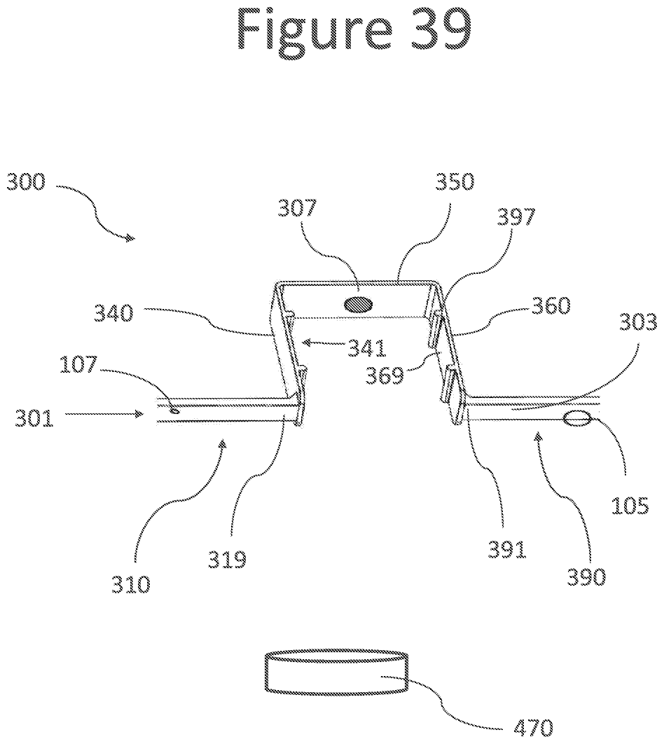

Referring now to FIG. 39, there is illustrated an embodiment of the mounting guide for placing a gang box 270 on a support structure that has an elongate, horizontal frame assembly 300 that has a longitudinal axis 301 with a horizontal body 303 with a proximal portion 310 and distal portion 390, a substantially proximal vertical portion 340 substantially perpendicular to the longitudinal axis 301 and extending from a distal end 319 of the proximal portion 310 of the frame assembly 300 and a substantially perpendicular distal vertical portion 360 extending from a proximal end of the distal portion 391 of the frame assembly 300, the distal vertical portion 360 and the proximal vertical portion 340 extending laterally at a substantially uniform width, a distal face of the proximal vertical portion 369 opposite a proximal face of the distal vertical portion 341. A middle portion of the frame assembly 350 is disposed between the distal vertical portion 360 and the proximal vertical portion 340 and parallel and substantially offset or disposed laterally from the distal portion 390 and proximal portion 310 of the frame assembly 300. One or more hoop or clip assemblies 105 is disposed on the frame assembly 300 designed to secure at least one wire assembly. One or more hole portions 107 are disposed through the frame assembly designed to receive a fastener assembly therethrough. In this embodiment, a support attachment 307 may be used to mount a gang box 270 to the horizontal frame assembly 300 to reflect a downward pull of gravity on the inventive concept when the inventive concept is in a horizontal orientation. One or more protrusions 397 may be disposed on the vertical portions of the frame assembly 340, 360.

FIG. 39 further illustrates one embodiment of the mounting guide for placing a gang box 270 on a support structure, this also a horizontally oriented embodiment of the horizontal frame assembly 300. In this embodiment, a paddle fan box may be attached 470.

The following patents are incorporated by reference in their entireties: U.S. Pat. Nos. and 2,962,281, 5,072,523, 5,966,828, 6,230,464, 6,233,838, 6,857,197, 7,373,730, 8,403,289, 9,397,491, 9,735,557, 4,241,510, 4,890,391, 6,958,448, 6,967,284, and 7,503,126.

While the inventive concept has been described above in terms of specific embodiments, it is to be understood that the inventive concept is not limited to these disclosed embodiments. Upon reading the teachings of this disclosure, many modifications and other embodiments of the inventive concept will come to mind of those skilled in the art to which this inventive concept pertains, and which are intended to be and are covered by both this disclosure and the appended claims. It is indeed intended that the scope of the inventive concept should be determined by proper interpretation and construction of the appended claims and their legal equivalents, as understood by those of skill in the art relying upon the disclosure in this specification and the attached drawings.

1. A mounting guide for placing a gang box on a wall structure comprising:
an elongate substantially planar vertical frame assembly having a longitudinal axis through a vertical body and having a top, middle, and bottom portion, the middle portion formed by a first lateral wall and a second lateral wall protruding laterally from the vertical body, wherein the first and second lateral walls are perpendicular to the longitudinal axis;
a laterally extendable box member adapted to be mounted within the middle portion of the vertical frame assembly and disposed between the top and bottom portions, the extendable box member adapted to move laterally away from the vertical body as upper and lower screw members that secure the box member are axially rotated, the upper and lower screw members perpendicular to the longitudinal axis and aligned with the first lateral wall and the second lateral wall;
a gang box member adapted to be mounted on a surface of the extendable box member located away from the vertical body, the gang box having an open end forming a plane that is parallel to the longitudinal axis of the vertical frame assembly;
one or more hoop or clip assemblies disposed on the frame assembly adapted to secure at least one wire assembly; and
one or more hole portions disposed through the frame assembly adapted to receive a fastener assembly therethrough.

2. The mounting guide for placing a gang box on a wall structure of claim 1 wherein the one or more loop or clip assemblies are adapted to secure the at least one wire assembly with one or more cable tie assemblies.

3. The mounting guide for placing a gang box on a wall structure of claim 1 wherein the one or more loop assemblies or clip assemblies is a metal-clad wiring bundle style wire holder assembly.

4. The mounting guide for placing a gang box on a wall structure of claim 1 wherein the width of the laterally extendable box member is substantially two inches and the laterally extendable box member is adapted to move laterally away from the vertical body up to one and a half inches.

5. A mounting guide for placing a gang box on a wall structure comprising:
an elongate, vertical frame assembly having a longitudinal axis with a vertical body with an upper portion and lower portion, a lower horizontal portion substantially perpendicular to the longitudinal axis and extending from a top end of the lower portion of the frame assembly and an upper horizontal portion extending from a bottom end of the upper portion of the frame assembly, the upper horizontal portion and the lower horizontal portion extending laterally at a substantially uniform width, an upper face of the lower horizontal portion opposite a lower face of the upper horizontal portion;
a middle portion of the frame assembly disposed between the upper horizontal portion and the lower horizontal portion and parallel and substantially offset or disposed laterally from the upper portion and lower portion of the frame assembly;
one or more hoop or clip assemblies disposed on the frame assembly adapted to secure at least one wire assembly; and
one or more hole portions disposed through the frame assembly adapted to receive a fastener assembly therethrough.

6. The mounting guide for placing a gang box on a wall structure of claim 5 wherein the one or more loop or clip assemblies are adapted to secure the at least one wire assembly with one or more cable tie assemblies.

7. The mounting guide for placing a gang box on a wall structure of claim 5 wherein the one or more loop assemblies or clip assemblies is a metal-clad wiring bundle style wire holder assembly.

8. The mounting guide for placing a gang box on a wall structure of claim 5 wherein a substantially horizontally planar foot portion is coupled to a bottom end of the lower portion of the frame assembly, the frame assembly adapted to rest on the foot portion when the foot portion is disposed on a surface, the lower portion extending upward from the foot portion a predetermined height for the placement of the gang box between the upper horizontal portion and the lower horizontal portion of the frame assembly.

9. The mounting guide for placing a gang box on a wall structure of claim 5 wherein the lower portion of the frame assembly is substantially ten inches in height.

10. The mounting guide for placing a gang box on a wall structure of claim 5 wherein the upper portion of the frame assembly is substantially eight inches or substantially twenty inches in height.

11. The mounting guide for placing a gang box on a wall structure of claim 5 wherein one or more loop or clip assemblies are spaced substantially six inches from the top end of the lower portion of the frame assembly or the bottom end of the upper portion of the frame assembly.

12. The mounting guide for placing a gang box on a wall structure of claim 5 wherein the substantially perpendicular lower horizontal portion extending from the top end of the lower portion of the frame assembly and the substantially perpendicular upper horizontal portion extending from the bottom end of the upper portion of the frame assembly, the upper horizontal portion and the lower horizontal portion extending laterally a substantially uniform width, are configured to enable the securing of the gang box to the frame assembly.

13. The mounting guide for placing a gang box on a wall structure of claim 12 wherein the spacing between the substantially perpendicular lower horizontal portion and the substantially perpendicular upper horizontal portion is substantially equal to the vertical height of the mounted gang box assembly, the perpendicular lower horizontal portion and the substantially perpendicular upper horizontal portion adapted to couple substantially contiguously to a bottom portion of the gang box assembly and a top portion of the gang box assembly to hold the gang box assembly substantially in place.

14. The mounting guide for placing a gang box on a wall structure of claim 13 wherein at least one clip and hook assembly is coupled to the lower horizontal portion and the upper horizontal portion of the frame assembly and adapted to secure the gang box assembly, the gang box assembly held substantially in place by the lower horizontal portion and the upper horizontal portion of the frame assembly.

15. The mounting guide for placing a gang box on a wall structure of claim 14 wherein one or more protrusions are disposed on the upper face of the lower horizontal portion of the frame assembly and the lower face of the upper horizontal portion of the frame assembly and adapted to prevent the gang box assembly from sliding outward from the lower horizontal portion and the upper horizontal portion of the frame assembly by coupling to corresponding groove portions of the gang box assembly.

16. A method for placing a gang box on a wall structure comprising:
mounting to a surface an elongate substantially planar vertical frame assembly having a longitudinal axis through a vertical body and having a top, middle, and bottom portion, the middle portion formed by a first lateral wall and a second lateral wall protruding laterally from the vertical body, wherein the first and second lateral walls are perpendicular to the longitudinal axis;
disposing one or more fastener assemblies through one or more hole portions of the vertical frame assembly to secure the vertical frame assembly to the surface;
laterally extending a predetermined distance an extendable box member disposed between the top and bottom portions of the frame assembly; and
positioning a gang box member mounted on a surface of the extendable box member, the box member located away from the vertical body, the gang box having an open end forming a plane that is parallel to the longitudinal axis of the vertical frame assembly, the gang box positioned in a predetermined location as measured by extending the box member.

17. The method for placing a gang box on a wall structure of claim 16 wherein the extendable box member is moved laterally away from the vertical body by axially rotating an upper screw member and a lower screw member disposed perpendicularly to the longitudinal axis of the frame assembly and aligned with the first lateral wall and the second lateral wall.

18. The method for placing a gang box on a wall structure of claim 17 wherein the laterally extendable box member is substantially two inches in width and is laterally extended up to one and a half inches from the vertical body.

19. The method for placing a gang box on a wall structure of claim 16 wherein one or more cable tie assemblies are used to attach at least one wire assembly to at least one loop or clip assembly on the vertical frame assembly.

20. The mounting guide of claim 5 wherein the middle portion is configured with a u-shaped configuration and adapted to slide vertically up and down the elongate vertical frame assembly to facilitate height adjustment of the gang box member.
